(19) United States
(12) Patent Application Publication
(10) Pub. No.: US 2014/0355642 A1
(43) Pub. Date: Dec. 4, 2014

(54) ELECTRIC ARC FURNACE AND METHOD OF OPERATING SAME

(71) Applicant: SMS Siemag AG, Duesseldorf (DE)

(72) Inventors: Guido Kleinschmidt, Moers (DE); Jan Bader, Alpen (DE); Klaus Schmale, Krefeld (DE); Rolf Best, Gladbeck (DE); Alexander Bergs, Rheine (DE); Thomas Henkel, Duisburg (DE); Detlef Strieder, Duisburg (DE); Peter Starke, Duisburg (DE); Markus Ertl, Mettmann (DE); Juergen Kunze, Xanten (DE)

(21) Appl. No.: 14/360,063

(22) PCT Filed: Nov. 15, 2012
(86) PCT No.: PCT/EP12/72707

§ 371 Date: Aug. 20, 2014

(30) Foreign Application Priority Data
Nov. 24, 2011 (DE) 102011087065.2

(51) Int. Cl. F27B 3/08

(52) U.S. Cl. CPC F27B 3/085
USPC 373/88

(57) ABSTRACT

The invention relates to an electric arc furnace and a method for operating same. The electric arc furnace comprises a lower vessel and a lid 120 placed on said lower vessel. The lower vessel has a tapping device for tapping molten metal. At least one electrode protrudes through the lid into the interior of the electric arc furnace, said electrode being held by an electrode holding device. A supply voltage device 150 is provided for supplying an electric direct current or alternating current to the electrode 130. The aim of the invention is to allow a continuous operation of the electric arc furnace. This is achieved in that the electrode holding device has an electrode adjusting device for adjusting the electrode dependent on the wear of the electrode and an electrode nippling device for nippling the electrode during the operation of the electric arc furnace. According to the invention, both the electrode adjusting device as well s the electrode nippling device 144 operate when the supply voltage of the electrode is switched on.

The invention relates to an electrical arc furnace and a method of operating same. The electrical arc furnace essentially comprises a lower vessel having a tapping device for tapping the melt and a lid which is placed on the lower vessel. At least one electrode protrudes through the lid into the interior of the electrical arc furnace. The electrode is held by an electrode holding device. There is provided a supply voltage device for supplying electrical voltage to the electrode to insure a continuous operation of the electrode over a number of melts.

Generally, electrical arc furnaces are very widely discussed in the state-of-the-art, e.g., in the following publications U.S. Pat. No. 4,423,514; U.S. Pat. No. 4,238,632; EP 0 269 465 B1; EP 1 181 492 B1; EP 8 430 020 B1; U.S. Pat. No. 4,805,186; EP 617 739 B1; EP 1 029 089 B1; EP 0 889 138 B1; DE 41 23 039 A1; DE 35 47 773 A1; DE 103 92 661 T5, and in the publication “Steel Production in Electrical Arc Furnaces” by Manfred Jollinghaus, Steel and Iron, No. 232232/11/94, third edition, pages 99-102.

Electrical arc furnaces for continuous production of metal by continuous melting of scrap, wherein the furnace is upright and stationary during tapping and, therefore should not be inclined, are disclosed in German laid-open publication DE 1 937 839 and U.S. Publication 2002/0071473 A1.

European Publication EP 1 779 705 B1 discloses an electrical arc furnace that can be operated as a direct current or alternative current electrical arc furnace. The electrical arc furnace which is disclosed therein, includes a control device for displacing the electrode during the melting process, for example, in order to prevent extinguishing of the electrical arc as a result of the shortening of the electrode due to wear or combustion, by a suitable displacement.

An electrical arc furnace for production of steel by a quasi continuous operation over six or seven days in discloses in European Patent EP 0 190 313 B1. An electrical arc furnace which is disclosed there, includes a lower vessel for production of melt by melting metal. The lower vessel has a tapping device for tapping the melt. The electrical arc furnace further includes a lid which is placed on the lower vessel, and at least one electrode which extends through an opening in the lid into the interior of the electrical arc furnace and is held by an electrode holding device. The electrode is supplied with electrical voltage provided by supply voltage device. For a continuous operation for several days, according to the teaching of EP 0 190 313 B1, the electrical supply voltage for the electrode is continuously turned on and remains turned-on also during charging of the furnace with iron carriers or additives, during refining of the melt by addition of alloy materials, during the second tapping during continuous operation, and naturally during the melting process itself. Tapping takes place regularly during the continuous operation of the electrical arc surface. It is contemplated that at each tapping, a sump height remains within 40%-50% of the maximum height of the bath level in the lower vessel as a residual sump. For tapping, the melt temperature is lifted to a desired tapping temperature. The lid of the electrical arc furnace is cooled by water. The quasi continuous operation of the electrical arc furnace is interrupted only for maintenance purposes. Then, the furnace and the damaged components which require repair, are exchanged or repaired.

Proceeding from this state-of-the art, the object of the invention is to modify the known electrical arc furnace and the method of operating the same so that the quasi continuous operation of the electric arc furnace is simplified.

This object is achieved by the subject matter of claim 1 characterized in that the electrode holding device has an electrode adjusting device for adjusting the electrode in accordance with its wear at a turned-on supply voltage and an electrode nippling device for nippling the electrode at the turned-on supply voltage.

The term “quasi continuous operation” means that the supply voltage for at least one electrode is continuously applied for a certain time period, i.e., is continuously turned on for a large number of melts and is only interrupted for maintenance work on the electrical arc surface.

The term “melt” has a double meaning in the present invention. On one hand, the term “melt” means a molten iron carrier. On the other hand, this term means a periodically repeated tapping cycle. In the second meaning, the term “melt” means a time period between two following one another tappings.

The term “nippling of the electrode” means lengthening of the existing electrode in the electrode holding device by screwing on an electrode strand at the end of actual electrode secured in the electrode holding device and which projects outwardly from the interior of the electrical arc surface.

With the above-mentioned nippling of the electrode that takes place at the turned-on supply voltage, an advantageous continuous operation of the electrical arc surface becomes possible, without the need to switch-off the electrical arc furnace for replacing a burn-up electrode. Also, the provision of a substitute electrode that only then is advanced through an additional opening in the lid of the electrical arc furnace and is subjected to the application of voltage when the other burn-up electrode must be replaced, makes the replacement of the electrode unnecessary for insuring the continuous operation.

The inventive electrical arc furnace is used for production of steel melt by melting an iron carrier in particular DRI, HBI and/or liquid and/or solid pig iron and/or scrap.

According to the first embodiment, it is advantageous when the lower vessel is formed so that it is upright and stationary during operation of the electrical arc furnace, in particular during carrying out tapping. The advantage consists in that the otherwise necessary tilt mechanism becomes unnecessary. During the slagging-off according to the invention, the electrical arc furnace remains preferably closed, i.e., the lid can remain on the lower vessel. The advantage of this consists in that the smelting process in the interior of the electrical arc surface would not be distorted, e.g., by the aspirated environment air which is the case when the lid is lifted. With the lifted lid, the environment air can be aspirated when the interior of the electrical arc furnace is under light vacuum because of a usually available suction device for flue gases. The advantage of a closed lower vessel and the resulting vacuum in its interior consists in that the necessary suction power for the flue gases is smaller than with a lifted lid, however, no environmental air should be aspirated. Also, the melt in the interior of the electrical arc furnace is not unnecessary displaced, as would be the case when the electrical arc furnace is tilted. Another advantage of the upright lower vessel consists in that the charging of the iron carriers or additives can take place during tapping, which was not possible when the lower vessel need be tilted for effecting tapping.

Not only the adjustment and nippling of the electrode but also charging of the electrical arc furnace with iron carriers and/or additives, introduction of the rinsing material or chemical energy carriers by the blow-in device in the interior of the electrical arc furnace, and/or rinsing material through the bottom of the lower vessel (not shown) take place, according to the invention, with turned-on and applied to the electrode supply voltage. The advantage of carrying out the above-mentioned steps with the turned-on supply voltage consists in that the operation of the electrical arc furnace need not be interrupted, i.e., its continuous operation is, thus, becomes possible.

The above-mentioned object is also achieved with the method for operating an electrical arc surface. The features and advantages of the method correspond to the above-mentioned advantages discussed with reference to the claimed electrical arc furnace.

The advantage of the claimed sump level height after carrying out tapping consists in that the service life of the fire-resistant material of the lower vessel is increased, and too large temperature variations in this region is prevented.

Further advantageous embodiments of the claimed electrical arc furnace and the claimed method of operating same are subject matter of dependent claims.

The description is accompanied by two figures, wherein:

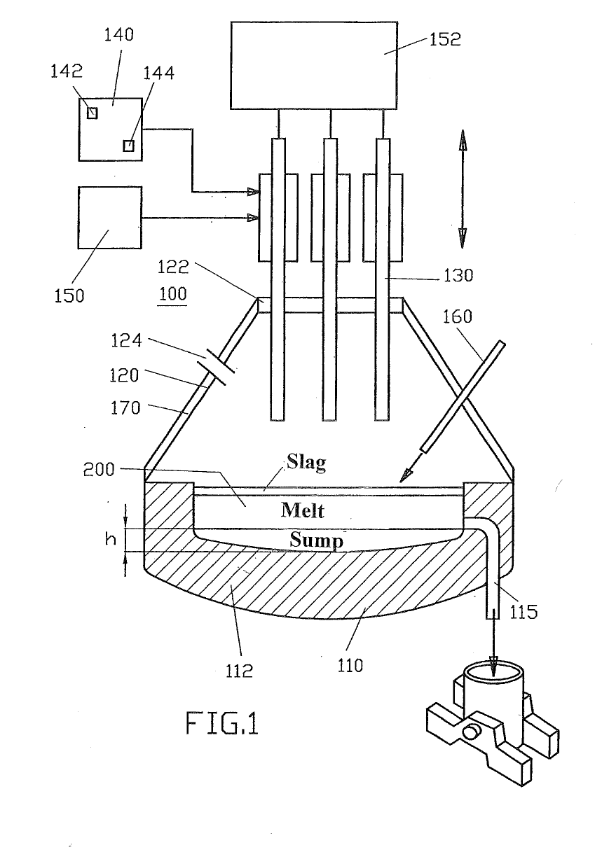

FIG. 1 shows a cross-sectional view of an electrical arc furnace according to the present invention; and

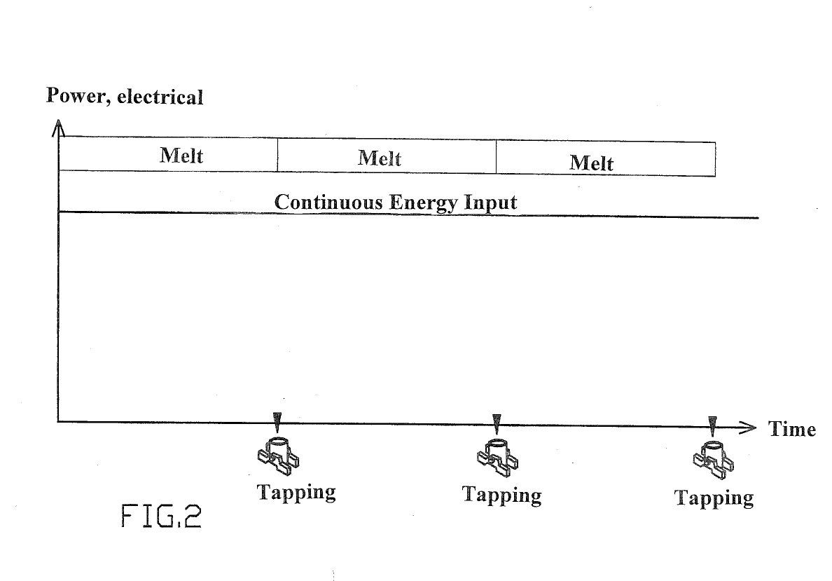

FIG. 2 shows a process of operating the electrical arc furnace according to the present invention.

The invention will be described below with reference to the above-mentioned drawings by way of exemplary embodiments.

FIG. 1 shows an inventive electrical arc furnace 100 having a lower vessel 110 and a lid 120 which is placed on the lower vessel. The lid is formed, e.g., conically and has a cooling device 170 for cooling its surface. The cooling device is formed, e.g., of tubular conduits in which cooling water flows. The lid has, in its center or its tip, at least one large first opening for receiving an electrode 130 that is advanced in the electrical arc furnace 100.

In addition to the first opening 122, the lid 120 has a second opening 124 for charging iron carriers and/or additives into the electrical arc furnace at the turned-on supply voltage. As an iron carrier, e.g., scrap, direct reduced iron (DRI) hot briquette iron (HBI) and/or liquid, and/or solid pig iron. Further, a blow-in device 160 is provided in the surface of the lid for feeding, e.g., rinsing material, or oxygen, or carbon in the interior of the electrical arc furnace, preferably, at turned-on supply voltage. As shown in FIG. 1, the blow-in device enables a targeted feeding of materials in an immediate vicinity of slag or melt.

During operation of the electrical arc furnace, the lower vessel 110 is upright and stationary. Therefore, the lid 120 must be displaced only in vertical direction, i.e., it can be lifted or lowered only in direction of the double arrow in FIG. 1. There can be provided a device for swinging of the lid, however, it is not absolutely necessary. E.g., for maintenance purposes, the lower vessel can be displaced.

The lower vessel is lined up with a fire-resistant material 112. After maintenance, the fire-resistant material must have such thickness in the lower vessel that it retains a sufficient residual thickness even after operation of the electrical arc furnace for several days. The lower vessel has a tapping device 115 for tapping the melt, preferably so that after each tapping, the sump level h remains at least 550 mm in the stationary lower vessel.

For holding the electrode 130 in the electrical arc furnace 100, there is provided an electrode holding device 140. It includes an electrode adjusting device 142 for adjusting the electrode 130 in accordance with its wear, and an electrode nippling device for nippling the electrode 130. According to the invention, both the electrode adjusting device 142 and the electrode nippling device 144 are so formed that they make possible adjustment and nippling of the electrode during the operation of the electrical arc furnace, at the turned-on supply voltage to the electrode 130. Thereby, in particular, a continuous operation of the electrical arc furnace over several tapping cycles or melts becomes generally possible.

For feeding electrical energy into the electrical arc furnace, there is provided a supply voltage device 150 for making available electrical supply voltage for at least one electrode. The supply voltage device can be formed as a d.c. source for making available supply voltage in form of d.c. voltage or as an a.c. source for making available supply voltage in form of a.c. voltage for the electrode 130. It includes a transformer 152 that according to the invention is located above the furnace lid. In case the supply voltage device is formed as the a.c. voltage source and the electrical arc furnace operates as alternating current AC-furnace, the transformer 152 has three single-phase transformers symmetrically arranged relative to each other at an angle of 120°.

Below, a method with which the electrical arc furnace operates according to the invention will be described in detail.

The main characteristic of the inventive method consists in that the electrical arc furnace operates in a “quasi” continuous operation over several days and a plurality of melts or tapping cycles. Only for maintenance purposes, after several days, the continuous operation is interrupted, and maintenance takes place.

The continuous operation becomes possible, on one hand, by using the electrode adjustment device which so advances the electrode 130 in the interior of the furnace during the operation of the electrical arc furnace that ideally the electrical arc length remains substantially constant despite the wear and burn-up of the electrode. In order that the operation of the electrical arc furnace even when a minimal length of the electrode 130 is reached, need not be interrupted, the present invention contemplates that in addition to the electrode adjusting device 142, there is provided an electrode nippling device 144 which insures that the electrode 130 again is lengthen at the top before reaching the minimal length. The so-called nippling typically is carried out by screwing on a lengthening electrode or a new electrode strand at the end of the electrode remote from the furnace. According to the invention, the electrode nippling device 144 insures the nippling of the electrode when the supply voltage is turned on so that the operation of the electrical arc furnace can continue during nippling.

However, not only the adjustment and nippling of the electrode 130, but also charging of the furnace with iron carriers or additives, blowing in of rinsing material, refining of the melt by addition of alloy materials, and in particular, tapping of the melt or slag takes place advantageously, according to the invention, with turned-on supply voltage for arbitrary time period during the operation. The advantage of this consists in that for the above-mentioned processes, the operation of the electrical arc furnace need not be interrupted, which results in noticeable costs savings in comparison with an interrupted operation of an electrical arc furnace.

The costs savings results from elimination of time-off that occurs in a discontinuous operation of an electrical arc furnace, during the production according to the inventive continuous operation. The available electrical power can be optimally used with the present invention. There is no need for any storage for the electrical energy and no other electrical consumer should be available for consuming the electrical power supplied by the supply voltaging device during off-times of an electrical arc furnace that operates intermittently. Also, the energy losses during feed-in are reduced because of a noticeably reduced number of turning-on and turning-off operation.

A timely continuous energy supply, i.e., with a continuous turned-on supply voltage for the electrode 130 over several tapping cycles or melt is shown in FIG. 2 graphically in an idealized form.

According to the present operating method, the electrical arc furnace operates during the continuous operation on average at a temperature of about 1,600° C. At the start of a planned tapping process that takes place at the turned-on supply voltage and in the upright position of the lower vessel, the melt temperature advantageously is slightly raised by about 50° C. to prevent a premature undesired cooling of the melt after it exits the electrical arc furnace. The tapping is preferably conducted in such a way that after tapping the height of the sump level remains at least at 500 mm in the deepest point of the lower vessel. The advantage of this consists in that the lower vessel is not damaged during an empty operation without melt at supplied voltage. Because of the available sump, the temperature variation of the melt and, thus, of the lower vessel are kept within limits. In this way, the load applied to the fire-resistant material is reduced and the service life of the lower vessel is increased. Not only tapping but also the adjustment and/or nippling of the electrode can take place during charging at a feed supply voltage.

1. An electrical arc furnace (100) for a quasi continuous operation, comprising:
a lower vessel (100) for melting iron carries, wherein the lower vessel has a tapping device (115) for tapping melt;
a lid (120) placeable on the lower vessel;
at least one electrode (130);
an electrode holding device (140) for holding the at least one electrode (130) through a first opening (112) in the lid (120) in an interior of the electrical arc furnace; and
a supply voltage device (150) for making available an electrical supply voltage for the electrode (130);
characterized in that
the electrode holding device (140) has an electrode adjusting device (142) for adjusting the electrode in accordance with its wear; and
an electrode nippling device (144) for nippling the electrode (130).

2. (canceled)

3. An electrical arc furnace (100) according to claim 1,
characterized in that
the lid (120) has at least one second opening (124) for charging iron carries and/or additives in the electrical arc furnace.

4. An electrical arc furnace (100) according to claim 1,
characterized in that
the lead has a blow-in device (160) for introducing rinsing material in an interior of the electrical arc furnace.

5. An electrical arc furnace (100) according to claim 1,
characterized in that
the lid (120) is conical.

6. An electrical arc furnace (100) according to claim 1,
characterized in that
the lid (120) has a cooling device (170) for cooling the lid.

7. An electrical arc furnace (100) according to claim 1,
characterized in that
the lid (120) is vertically displaceable relative to the stationary lower vessel (110) during operation of the electrical arc furnace.

8. An electrical arc furnace (100) according to claim 1,
characterized in that
the supply voltage device (150) is formed as d.c. voltage source or a.c. voltage source for making available supply voltage for the electrode in form of d.c. voltage or a.c. voltage.

9. An electrical arc furnace (100) according to claim 1,
characterized in that
the supply voltage device (150) has a transformer (152) which is located above the lid (120).

10. An electrical arc furnace according to claim 9,
characterized in that
with the supply voltage device being formed as an a.c. voltage source, the transformer (152) has three single-phase transformers which are symmetrically arranged relative to each other at an angle of 120°.

11. An electrical arc furnace (100) according to claim 1,
characterized in that
the lower vessel (110) is lined up with a fire-resistant material.

12. A method of operating an electrical arc furnace (100) in a quasi continuous operation and having a lower vessel (110), a lid (120) placeable on the lower vessel, and at least on electrode (130) displaceable through a first opening (122) in the lid (120) into the interior of the electrical arc furnace, comprising the following steps:
charging iron carriers or additives into the electrical arc furnace through at least one second opening (124) in the lid;
time—continuously feeding supply voltage to the electrode (130) for melting an iron carrier introduced into the electrical arc furnace for the continuous operation of the electrical arc furnace over several melts,
characterized in that
the at least one electrode is adjusted and nippled, and tapping of the melt takes place at the upright and stationary lower vessel (110).

13. A method according to claim 11,
characterized in that
the charging of the electrical arc furnace (100) with iron carrier or additive and the blowing-in of the rinsing material in the electrical arc furnace takes place.

14. A method according to claim 12,
characterized in that
the electrical arc furnace is continuously operated at an average temperature of about 1600° C.

15. (canceled)

16. A method according to claim 11,
characterized in that
the tapping is so carried out that after tapping, the height of the sump level (h) in the lower vessel remains at least 500 mm.

17. A method according to claim 11,
characterized in that
the electrical arc furnace (100) is operated for a short time with a temperature of about 1650° for tapping the melt.

18. A method according to claim 12,
characterized in that
after the adjustment and/or nippling of the electrode can take place during charging.
